(19) United States
(12) Patent Application Publication
(10) Pub. No.: US 2014/0115547 A1
(43) Pub. Date: Apr. 24, 2014

(54) Method of Generating Parameterized Units

(71) Applicant: Semitronix Corporation, Hangzhou (CN)

(72) Inventor: YONGJUN ZHENG, Hangzhou (CN)

(73) Assignee: Semitronix Corporation, Hongzhou (CN)

(21) Appl. No.: 13/897,399

(22) Filed: May 18, 2013

(30) Foreign Application Priority Data
Oct. 22, 2012 (CN) 201210401119.0

(51) Int. Cl. G06F 17/50

(52) U.S. Cl. CPC G06F 17/5081
USPC 716/102

(57) ABSTRACT

The present invention relates to a method of method of generating parameterized integrated circuit units in a plurality of platforms. The said method comprising: (1) designing parameterized units in a graphic user interface and defining their constrain relations; (2) transforming the parameterized units to scripts. The invention providing a method of designing parameterized units in a graphical user interface without editing parameterized unit scripts, reducing the complexity of the design process and the design cycle; in addition, it is very easy for users to design and maintenance; at the same time, increasing the portability.

### CROSS REFERENCE TO RELATED PATENT APPLICATION

The present application claims the priority of the Chinese patent application No. 201210401119.0 filed on Oct. 22, 2012, which application is incorporated herein by reference

### FIELD OF THE INVENTION

The present invention relates generally to the field of designing and manufacturing semiconductors, and more specifically, to a method of generating parameterized integrated circuit units in a plurality of platforms.

### BACKGROUND OF THE INVENTION

Parameterized units need to be designed in the process of designing and manufacturing integrated circuit chips. For example, the semiconductor manufacturer will provide to the design company process development kit (PDK), and there are many parameterized units in the PDK that will be called to meet different needs when the design company designs a chip. In addition, semiconductor manufacturers use parameterized units to generate large numbers of test patterns and test circuits quickly for yield and process learning during process technology development. Therefore, in the fields of semiconductor design and manufacturing, there exists the need to mass design and generate numerous parameterized units.

Essentially, parameterized units are computer scripts, or computer programs, which record the calculation relations between parameters and varieties of parameter information. Presently in the semiconductor industry, the main method of designing parameterized units is engineers writing scripts, and generating parameterized units after debugging. The specific design process is shown in FIG. 1: (1) editing parameterized unit scripts, the scripts must follow the syntax of the scripting language provided by a platform, using the command set to realize parameterized units, and the command set is supported by the platform; (2) compiling parameterized unit scripts which were formed in step (1), modify them until the compiler is free from any syntax errors; (3) debugging parameterized unit scripts which compiled in step (2), ensuring that they meet the requirements of parameterized units, and that the constraint relations of different namespace variables are correct, and if not, modifying the parameterized unit scripts by repeating steps (1) and (2) until they are correct; (4) debugging and writing to a database. Although this method has been commonly practiced in the semiconductor industry, it is in many cases inefficient and inadequate. The inadequacies of this process include that: (1) For the engineer, designing parameterized unit scripts is very complex, debugging them is difficult, cycle time of the design is long because designing and debugging a parameterized unit requires a lot of time; furthermore, this method requires the engineers to have significant programming skills; (2) for the user of the parameterized units, the scripts represent relatively poor readability and maintainability; (3) different software platform for designing parameterized units has different script syntax and thus parameterized units are dependent on the software platform, therefore it is difficult to realize script transplantation between different software platforms.

### SUMMARY OF THE INVENTION

In view of the inadequacy of prior arts, a method of generating parameterized units is proposed in the present invention.

Aspects of the invention include:
(1) designing parameterized units in a graphical user interface, and defining their constraint relations;
(2) transforming the parameterized units to scripts.

The said graphical user interface includes layout editing tool, the said parameterized units are geometric shapes, the method of designing parameterized units comprises creating several geometries, and then, defining their constraint relations, the process of transforming the parameterized units to scripts comprising: analyzing the geometries of parameterized units and corresponding parameters of the geometries, and storing them; analyzing constraint relations and modifying parameters which correspond to geometries; translating the stored geometries and corresponding parameters of geometries into text according to corresponding syntax.

The constraint relations are distance constraint relations or alignment constraint relations, the positions of geometric shapes and sizes of parameterized units are changed through the constraint relations.

wherein, a step can be created between step (1) and step (2):

debugging the constrain relations to reach the corresponding requirements, it need to return to the graphic user interface to carry on the modification if don't meet your requirement until debugging through.

wherein, a step can be created after step (2):

importing the scripts to corresponding design platform of parameterized units, compiling and generating parameterized units, finally, storing the parameterized units to data base.

The present invention provides many beneficial functions:

designing parameterized units in a graphical user interface without editing parameterized unit scripts, reducing the complexity of the design process;
in the process of designing parameterized units, the complexity of design and design cycle are decreased by defining constraint relations of geometric shapes;
it is very visual designing parameterized units in a graphical user interface, and easy for users to design and maintenance;
generating parameterized unit scripts automatically, the parameterized unit scripts can generate parameterized units in different design platforms, increasing the portability.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 is a flow diagram of a method to generate parameterized units of present technology;

FIG. 2 is the flow diagram of a method to generate parameterized units of present invention;

FIG. 3 is the schematic diagram of designing parameterized units in a graphical user interface of the present invention;

FIG. 4 is the flowchart of transforming the parameterized units of the present invention;

FIG. 5 is a schematic diagram of using distance constraint relations operation of the present invention;

FIG. 6 is a schematic diagram of using alignment constraint relations operation of the present invention;

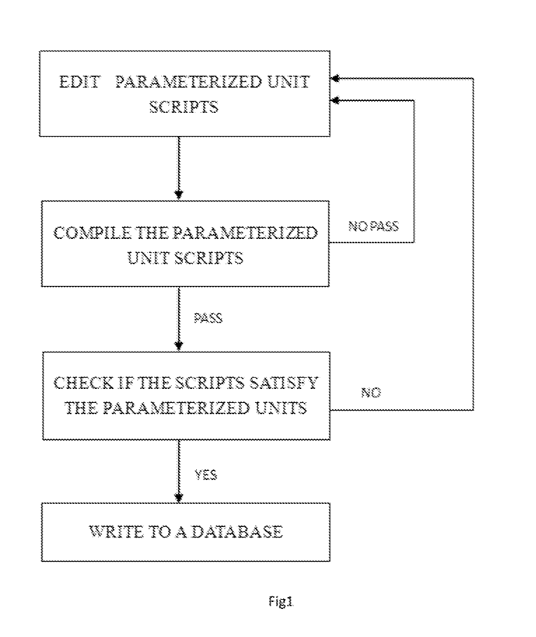

### DETAIL DESCRIPTION OF THE PREFERRED EMBODIMENTS

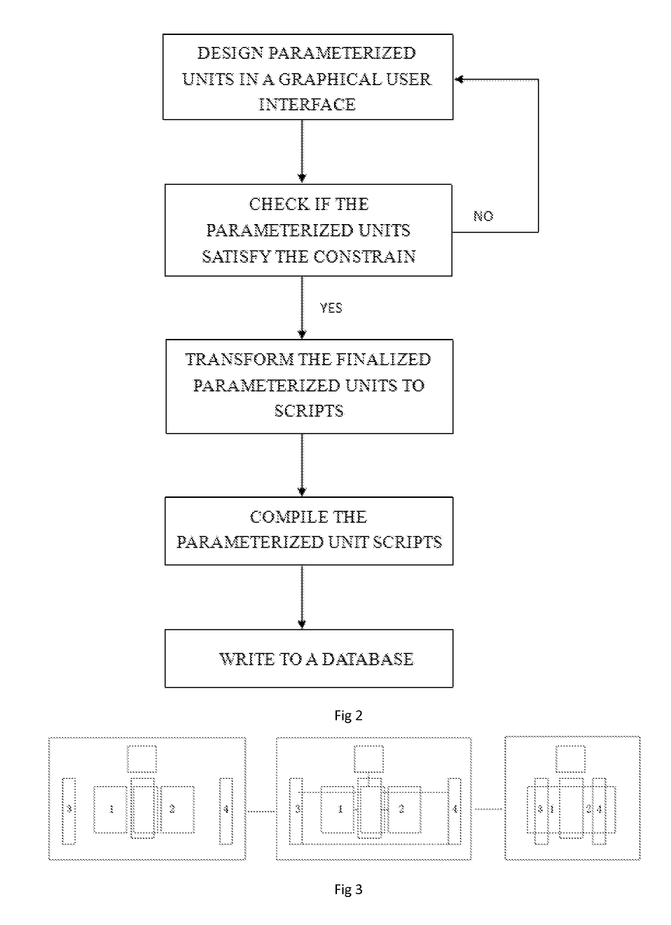

FIG. 2 is a flow diagram of a method to generate parameterized units of present invention.

(1) designing parameterized units in a graphical user interface, and defining their constraint relations.

Check if the parameterized units satisfy the constrain relations; if not, these parameterized units are to be modified in the graphic user interface until constrain relations are satisfied.

(2) transforming the finalized parameterized units to scripts.

Importing the scripts to corresponding design platform of parameterized units, compiling and generating parameterized units, finally, storing the parameterized units to database.

### Example 1

### The Constraint Relations are Distance Constraint Relations

The graphical user interface makes use of layout editing tools; in addition, the parameterized units are geometric shapes. FIG. 3 is the schematic diagram of designing parameterized units in a graphical user interface of the present invention. It should be understood that the invention includes the following steps when the constraint relations are distance constraint relations:

Creating two rectangles 1 and 2 in a graphical user interface, and defining the initial value of the distance of their rectangular sides as zero. FIG. 5 is a schematic diagram of using distance constraint relations operation of the present invention. As shown in FIG. 5, the distance between two rectangles is zero under the distance constraint relations.

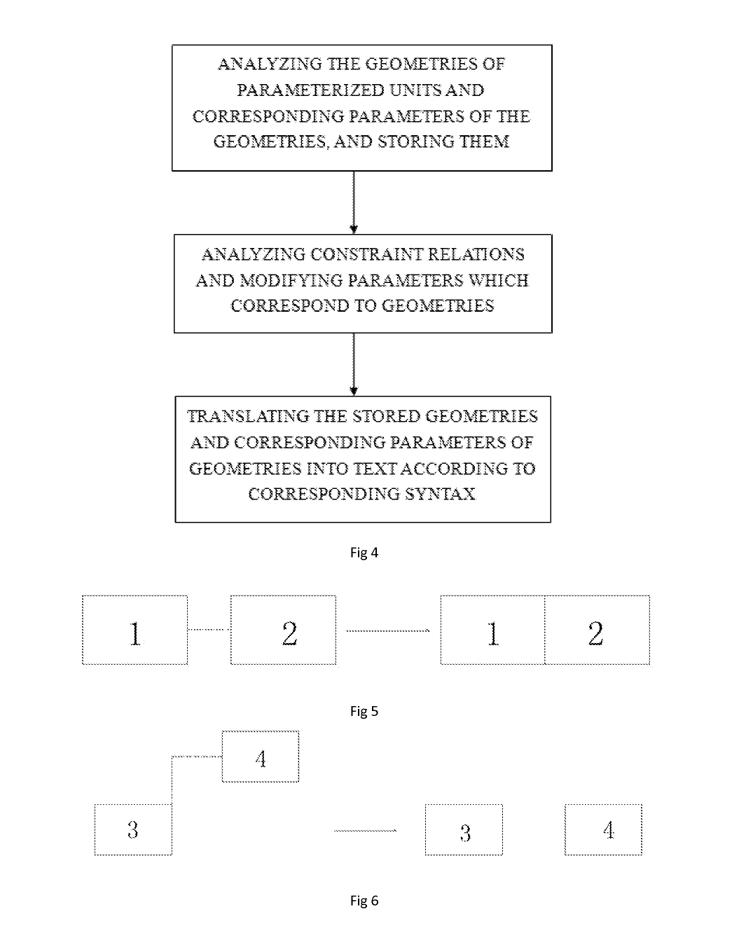

Transforming the finalized parameterized units to scripts. The transformation process is shown in FIG. 4, it includes: first, analyzing the geometries of parameterized units and corresponding parameters of the geometries, and storing them; then, analyzing constraint relations and modifying parameters which correspond to geometries; finally, translating the stored geometries and corresponding parameters of geometries into text according to corresponding syntax.

Importing the scripts to corresponding design platform of parameterized units, compiling and generating parameterized units, finally, storing the parameterized units to database.

### Example 2

### The Constraint Relations are Alignment Constraint Relations

The graphical user interface makes use of layout editing tools; in addition, the parameterized units are geometric shapes. FIG. 3 is the schematic diagram of designing parameterized units in a graphical user interface of the present invention. It should be understood that the invention includes the following steps when the constraint relations are alignment constraint relations:

(1) Creating two rectangles 3 and 4 in a graphical user interface, and defining the centers of the two rectangular sides in an alignment constraint relation in the vertical direction. FIG. 6 is a schematic diagram of using alignment constraint relations operation of the present invention. In FIG. 6, the two rectangles are defined where the centers of corresponding rectangular sides are aligned through the said constraint relation.

(2) Transforming the finalized parameterized units to scripts. The transformation process is shown in FIG. 4, which includes: first, analyzing the geometries of parameterized units and corresponding parameters of the geometries, and storing them; then, analyzing constraint relations and modifying parameters which correspond to geometries; finally, translating the stored geometries and corresponding parameters of geometries into text according to corresponding syntax.

Importing the scripts to corresponding design platform of parameterized units, compiling and generating parameterized units, finally, storing the parameterized units to database.

1. A method of generating parameterized units, the method comprising steps of:
1) designing parameterized units in a graphic user interface and defining parameterized units' constraint relations;
2) transforming the parameterized units to scripts.

2. The method of generating parameterized units of claim 1, wherein the graphic user interface includes a map editing tool, the parameterized units are geometric shapes, the method of designing parameterized units comprises creating several geometries and then defining their constraint relations.

3. The method of generating parameterized units of claim 1, wherein the step of transforming the parameterized units to scripts comprises:
analyzing the geometries of parameterized units and geometry corresponding parameters thereof, and storing them;
analyzing constraint relations and modifying parameters which correspond to geometries;
translating the stored geometries and geometry corresponding parameters into text according to corresponding syntax.

4. The method of generating parameterized units of claim 2, wherein the constraint relations are distance constraint relations or alignment constraint relations.

5. The method of generating parameterized units of claim 1, wherein, an additional step exists between the first step and the second step, the additional step is: when the parameterized units do not satisfy the constraint relations, these parameterized units are to be modified in the graphic user interface until constraint relations are satisfied.

6. The method of generating parameterized units of claim 1, wherein, an additional step may exist after the second step, the additional step is:
importing the scripts of parameterized units to a script-based design platform, compiling and generating parameterized units, and finally, storing the parameterized units to a database.
